(19) United States
(12) Patent Application Publication
(10) Pub. No.: US 2006/0169506 A1
(43) Pub. Date: Aug. 3, 2006

(54) Hybrid vehicle

(75) Inventors: Kazunori Handa, Nishio-shi (JP); Koji Tanihata, Toyota-shi (JP)

Correspondence Address: BIRCH STEWART KOLASCH & BIRCH, PO BOX 747, FALLS CHURCH, VA, 22040-0747, US

(73) Assignee: Mitsubishi Jidosha Kogyo Kabushiki Kaisha

(21) Appl. No.: 11/315,269

(22) Filed: Dec. 23, 2005

(30) Foreign Application Priority Data
Jan. 28, 2005 (JP) 2005-021639

(51) Int. Cl. B60K 1/00

(52) U.S. Cl. 180/65.5

(57) ABSTRACT

In a hybrid vehicle, a planetary gear train is arranged between an engine and a generator such that the driving force of the engine can be distributed through the planetary gear train to be transmitted to front wheels and the generator. In-wheel motors are incorporated in the front wheels, respectively, so as to drive the respective front wheels.

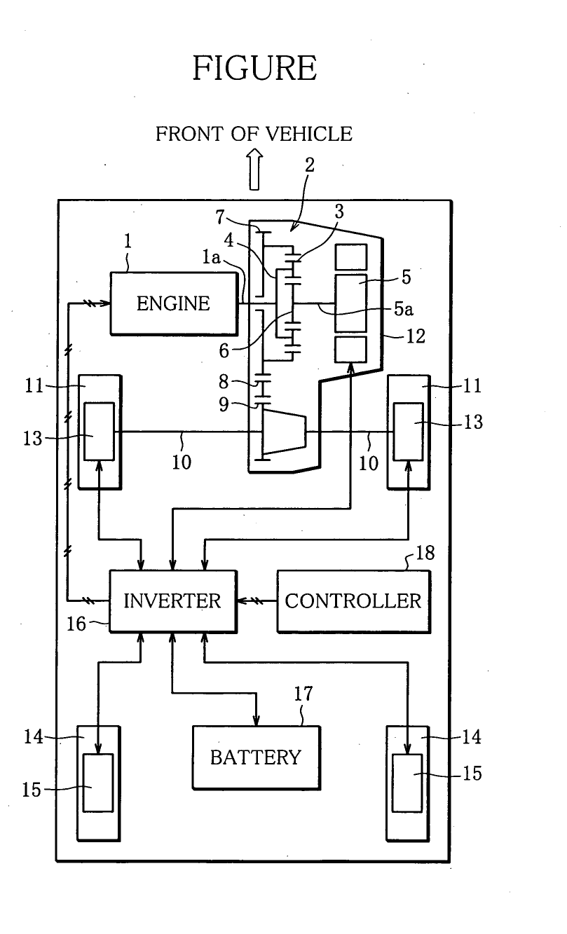

### BACKGROUND OF THE INVENTION

1. Field of the Invention

The present invention relates to a parallel hybrid vehicle using an engine and a motor as power sources for running the vehicle.

2. Description of the Related Art

This type of parallel hybrid vehicle has been proposed, for example, in Unexamined Japanese Patent Publication No. 2004-156763 (hereinafter referred to as Patent Document 1) in which the driving force of the engine is partly distributed through a planetary gear train to a generator for generation of electricity.

In the hybrid vehicle disclosed in Patent Document 1, the output shaft of the engine is connected to the carrier of the planetary gear train, the generator arranged between the engine and the planetary gear train is connected to the sun gear of the planetary gear train, and a motor arranged on the side of the planetary gear train opposite the engine is connected to the ring gear of the planetary gear train. The ring gear of the planetary gear train is coupled to driving wheels through a reduction gear and a differential gear. While the vehicle is run by the engine, the generator is driven by the driving force of the engine through the carrier and the sun gear of the planetary gear train. The load of electricity generation applied at this time by the generator restrains rotation of the sun gear, with the result that the driving force of the engine is transmitted to the driving wheels through the carrier, the pinion gear, and the ring gear. While the vehicle is run by the motor, on the other hand, the driving force of the motor is transmitted to the driving wheels through the ring gear.

Thus, in the hybrid vehicle disclosed in Patent Document 1, it is necessary that the engine, the generator and the motor should be connected to the respective elements of the planetary gear train. For this reason, the generator is located between the engine and the planetary gear train, while the motor is located on the side of the planetary gear train opposite the engine. As a result, the engine, the generator, the planetary gear train and the motor are arranged in series.

However, where the engine, the generator, the planetary gear train and the motor are arranged in series as in the hybrid vehicle disclosed in Patent Document 1, the overall length of the power train including the engine (in Patent Document 1, the length in the width direction of the vehicle) increases, lowering mountability of the power train into vehicles. Especially in the case of a vehicle equipped with a high-output engine, the generator is required to apply an increased electricity generation load in order to restrain rotation of the sun gear. This, however, leads to increase in the size of the generator and thus in the overall length of the power train, making the aforesaid drawback more noticeable.

Moreover, the generator, which originally requires protection against heat generated thereby, is located next to the engine. Consequently, the heat load of the generator increases due to heat transferred from the engine, giving rise to a problem that more elaborate measures against heat are required.

### SUMMARY OF THE INVENTION

One aspect of the present invention is a hybrid vehicle comprising: an engine for producing driving force; a generator having an input shaft and adapted to generate electricity as the input shaft is rotated; a power transfer device arranged between the engine and the generator, the power transfer device being capable of distributing the driving force of the engine to be transmitted to the generator and wheels of the vehicle; and a motor arranged at a position different from a position where the power transfer device is arranged, the motor being capable of transmitting driving force produced thereby to the wheels or to other wheels.

### BRIEF DESCRIPTION OF THE DRAWINGS

The present invention will become more fully understood from the detailed description given hereinafter and the accompanying drawing which are given by way of illustration only, and thus, are not limitative of the present invention, and wherein:

The FIGURE shows an entire construction of a hybrid vehicle according to an embodiment of the present invention.

### DETAILED DESCRIPTION OF THE PREFERRED EMBODIMENTS

A hybrid vehicle according to one embodiment of the present invention will be hereinafter described in detail.

The FIGURE shows an entire construction of the hybrid vehicle according to the embodiment, and as illustrated, the hybrid vehicle is configured basically as a front-wheel-drive vehicle with horizontal engine. An internal combustion engine 1 has an output shaft la connected to a carrier 4 of a planetary gear train 2 (power transfer device), and the carrier 4 supports pinion gears 3 of the gear train 2. A generator 5 is arranged on the other side of the planetary gear train 2 opposite the engine 1 and has an input shaft 5a connected to a sun gear 6 of the planetary gear train 2. A reduction gear 8 meshes with a ring gear 7 of the planetary gear train 2, and right and left front wheels (first wheels) 11 are coupled to the reduction gear 8 through a differential gear 9 and drive shafts 10.

Thus, during operation of the engine 1, the carrier 4 of the planetary gear train 2 rotates together with the engine output shaft la, so that the generator 5 is driven through the pinion gears 3 and the sun gear 6 to generate electricity. At this time, rotation of the sun gear 6 is restrained by an amount corresponding to a load of electricity generation by the generator 5. Consequently, part of the driving force of the engine 1 is transmitted from the carrier 4 to the front wheels 11 through the pinion gears 3, the ring gear 7, the reduction gear 8, the differential gear 9 and the drive shafts 10, to rotate the front wheels 11.

The planetary gear train 2, the generator 5, the reduction gear 8 and the differential gear 9 are housed in a gear case 12. A housing of the generator 5 has an oil jacket, not shown, for storing oil. The oil in the oil jacket is circulated via an oil cooler arranged outside the gear case 12 to cool the whole generator 5.

The right and left front wheels 11 each have an electric in-wheel motor 13 incorporated therein. The construction of the in-wheel motor 13 is known in the art, and therefore, detailed description thereof is omitted. Each in-wheel motor 13 is swingably supported on the suspension of a corresponding one of the right and left front wheels 11 and has a rotor coupled, for example, to the drive shaft 10 coaxially therewith. An annular stator is placed around the outer periphery of the rotor, and a coil is attached to the stator. When the coil is energized, a magnetic field is produced between the coil and a magnet of the rotor, so that the rotor is given torque. Consequently, the front wheels 11 are rotated, together with the drive shaft 10, by the in-wheel motors 13.

Also, right and left rear wheels (second wheels) 14 of the vehicle are provided with electric in-wheel motors 15, respectively, which are identical in construction with the in-wheel motors 13, and are rotated by these in-wheel motors 15.

The generator 5 and the in-wheel motors 13 and 15 are electrically connected via an inverter 16 to a battery 17 for running, and the inverter 16 is electrically connected to a controller 18. Based on the amount of operation of the accelerator, vehicle speed, etc., the controller 18 performs powering control and regeneration control on the generator 5 and the in-wheel motors 13 and 15 through the inverter 16, and also carries out fuel injection control and ignition timing control for the engine 1. The following describes how the engine 1, the generator 5 and the in-wheel motors 13 and 15 operate under the control of the controller 18.

The vehicle of this embodiment is basically run by the motors, and the engine 1 is used as needed to assist the running of the vehicle. Specifically, during low-speed running in which the running load is low, the in-wheel motors 13 and 15 of the front and rear wheels 11 and 14 are operated with the engine 1 stopped, to drive the front and rear wheels 11 and 14 by the driving forces of the in-wheel motors 13 and 15 and thereby cause the vehicle to run. In this case, as the front wheels 11 rotate, the rotation is transmitted to the planetary gear train 2 through the drive shafts 10 and thus the ring gear 7 is driven. At this time, the carrier 4 remains stationary because the engine 1 is stopped, and also operation of the generator 5 is stopped (i.e., no electricity generation load is applied), so that the sun gear 6 and the pinion gears 3 can rotate idle and permit the rotation of the ring gear 7. Consequently, the front wheels 11 are allowed to rotate by means of the driving forces of the in-wheel motors 13.

When the accelerator is depressed by the driver and thus an increased driving force of the vehicle is required, the generator 5 starts to operate and its electricity generation load restrains the idle rotation of the sun gear 6. As a result, the rotation of the ring gear 7 being driven by the front wheels 11 is transmitted through the pinion gears 3 and the carrier 4 to the engine 1, whereupon the engine 1 is started. After the engine 1 is started, the driving force of the engine 1 is transmitted through the carrier 4, the pinion gears 3 and the ring gear 7 to the front wheels 11 because the rotation of the sun gear 6 is restrained by the electricity generation load of the generator 5. Consequently, the front wheels 11 are driven by the engine 1 as well as by the in-wheel motors 13. A vehicle driving force corresponding to the amount of operation of the accelerator can therefore be achieved. Also, as the sun gear 6 rotates, the generator 5 starts to generate electricity and the generated electric power is charged in the battery 17.

The distribution ratio in which the driving force of the engine 1 is distributed to the front wheels 11 and the generator 5 varies depending on the operating state of the planetary gear train 2, more specifically, the degree to which the rotation of the sun gear 6 is restrained by the load of electricity generation by the generator 5. During operation of the engine, the electricity generation load of the generator 5 is controlled so that the engine 1 may always be operated in a rotation region with a minimum rate of fuel consumption.

On the other hand, during deceleration of the vehicle, the fuel supply to the engine 1 is cut off and the in-wheel motors 13 and 15 of the front and rear wheels 11 and 14 function as generators under the regeneration control. Also, if SOC (State Of Charge) of the battery 17 drops below a predetermined value, the engine output is increased to apply additional torque to the generator 5 so that the increased electric power generated by the generator 5 may be charged in the battery 17.

The arrangement of the members constituting the power train of the hybrid vehicle of this embodiment will be now explained in comparison with the arrangement disclosed in the aforementioned Patent Document 1.

In the hybrid vehicle of Patent Document 1, the motor is arranged on the side of the planetary gear train opposite the engine; in this embodiment, the in-wheel motors 13 and 15 are incorporated into the respective front and rear wheels 11 and 14. Also, in Patent Document 1, the generator is arranged between the engine and the planetary gear train; in this embodiment, the generator is arranged in the space which is secured on the side of the planetary gear train 2 opposite the engine 1 by the removal of the motor as aforesaid.

Consequently, in this embodiment, the engine 1, the planetary gear train 2 and the generator 5 are arranged in series along the width direction of the vehicle, and the overall length of the power train including the engine 1 is shorter than that of the power train of Patent Document 1 by an amount corresponding to the length of the motor. According to this embodiment, therefore, mountability of the power train into vehicles can be remarkably improved. Also, even in the case where the generator 5 is required to apply an increased electricity generation load in order to restrain rotation of the sun gear 6 because of use of a high-output engine and thus a large-sized generator 5 needs to be mounted, such a large-sized generator 5 can be mounted on the vehicle without hindrance because the overall length of the power train is short from the outset.

Further, since the generator 5 is arranged on the side of the planetary gear train 2 opposite the engine 1, heat transfer from the engine 1 to the generator 5 can be significantly reduced. Consequently, the production cost can be cut down by simplifying the structure for protecting the generator 5 against heat, more specifically, by reducing the size of the oil cooler for cooling the generator or by changing the cooling system from an oil cooling type to an air cooling type which is simpler in structure. Moreover, the generator 5 can be more reliably prevented from malfunctioning due to overheating, thus enhancing reliability.

The in-wheel motors 13 and 15 are used as motors for driving the front and rear wheels 11 and 14. It is therefore unnecessary to make room for the motors inside the vehicle body, whereby the space in the vehicle body can be saved.

In addition, the planetary gear train 2, which is compact in size, is used as the power transfer device for distributing the driving force of the engine 1 to the front wheels 11 and the generator 5, and this also serves to shorten the overall length of the power train.

While the preferred embodiment has been described, it is to be noted that the present invention is not limited to the foregoing embodiment alone. For example, in the hybrid vehicle of the above embodiment, the driving force of the engine 1 is transmitted to the front wheels 11. Alternatively, the driving force of the engine 1 may be transmitted to the rear wheels 14 only or to all of the front and rear wheels 11 and 14.

Also, in the foregoing embodiment, all of the front and rear wheels 11 and 14 are driven by the respective in-wheel motors 13 and 15. Alternatively, for example, the rear wheels 14 may be driven by an ordinary motor mounted on the vehicle body, or the in-wheel motors 15 of the rear wheels 14 may be omitted so that only the front wheels 11 may be driven by the respective in-wheel motors 13. Also, the in-wheel motors 13 of the front wheels 11 may be omitted so that only the rear wheels 14 may be driven by the respective in-wheel motors 14 or an ordinary motor mounted on the vehicle.

Further, the power transfer device to be used is not limited to the planetary gear train 2, and other suitable mechanism may be used to distribute the driving force to the front wheels 11 and the generator 5.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A hybrid vehicle comprising:
an engine for producing driving force;
a generator having an input shaft and adapted to generate electricity as the input shaft is rotated;
a power transfer device arranged between the engine and the generator, the power transfer device being capable of distributing the driving force of the engine to be transmitted to the generator and first wheels of the vehicle; and
a motor arranged at a position different from a position where the power transfer device is arranged, the motor being capable of transmitting driving force produced thereby to the first wheels.

2. The hybrid vehicle according to claim 1, wherein the motor comprises in-wheel motors incorporated in the respective first wheels.

3. The hybrid vehicle according to claim 2, further comprising a separate motor provided separately from the in-wheel motors, to drive second wheels separate from the first wheels.

4. The hybrid vehicle according to claim 3, wherein the separate motor comprises in-wheel motors incorporated in the second wheels, respectively.

5. The hybrid vehicle according to claim 1, wherein the power transfer device comprises a planetary gear train for varying a distribution ratio in which the driving force of the engine is distributed to the first wheels and the generator, in accordance with an operating state thereof.

6. The hybrid vehicle according to claim 5, wherein the planetary gear train has a sun gear to which an input shaft of the generator is connected, a carrier which supports a pinion gear in mesh with the sun gear and to which an output shaft of the engine is connected, and a ring gear which meshes with the pinion gear and through which the driving force of the engine is transmitted to the first wheels.

7. A hybrid vehicle comprising:
an engine for producing driving force;
a generator having an input shaft and adapted to generate electricity as the input shaft is rotated;
a power transfer device arranged between the engine and the generator, the power transfer device being capable of distributing the driving force of the engine to be transmitted to the generator and first wheels of the vehicle; and
a motor arranged at a position different from a position where the power transfer device is arranged, the motor being capable of transmitting driving force produced thereby to second wheels separate from the first wheels.

8. The hybrid vehicle according to claim 7, wherein the motor comprises in-wheel motors incorporated in the second wheels, respectively.

9. The hybrid vehicle according to claim 7, wherein the power transfer device comprises a planetary gear train for varying a distribution ratio in which the driving force of the engine is distributed to the first wheels and the generator, in accordance with an operating state thereof.

10. The hybrid vehicle according to claim 9, wherein the planetary gear train has a sun gear to which an input shaft of the generator is connected, a carrier which supports a pinion gear in mesh with the sun gear and to which an output shaft of the engine is connected, and a ring gear which meshes with the pinion gear and through which the driving force of the engine is transmitted to the first wheels.
